(19) United States
(12) Patent Application Publication
(10) Pub. No.: US 2017/0015529 A1
(43) Pub. Date: Jan. 19, 2017

(54) Lifting Device and Method for Lifting Brittle Elements

(71) Applicant: Obelix Holdings Pty Limited, North Sydney (AU)

(72) Inventors: Ernest Frederick Comerford, Glen Aplin (AU); Mark Andrew Rankin, Seven Hills (AU); Pat Kelly, Regents Park (AU)

(21) Appl. No.: 15/220,491

(22) Filed: Jul. 27, 2016

Related U.S. Application Data
(63) Continuation-in-part of application No. 13/125,593, filed on Jul. 13, 2011, now Pat. No. 9,409,751.

(30) Foreign Application Priority Data
Oct. 23, 2008 (AU) 2008905461

(51) Int. Cl. B66C 1/66; B28D 1/14; E04G 21/14

(52) U.S. Cl. CPC B66C 1/66; E04G 21/14; B28D 1/146

(57) ABSTRACT

A lifting device for brittle elements such as bridge beam and deck elements, panels and the like up to and beyond 1,000 tonnes is described. The lifting device may be suitable for face and edge lifting of brittle elements that have a suitable cavity formed within or through them. The lifting device may include a lifting eye connected to an elongate member/shank that has a flared end. A sleeve about the shank may be used to raise and lower the moveably attached wedges to and from the flared end. In use the wedges upon the flared end prevent the withdrawal of the lifting device from the cavity of the brittle element. A cavity former is also described that may be used in the casting of the brittle element to form a suitable cavity.

The present patent document is a continuation-in-part of copending U.S. patent application Ser. No. 13/125,593, filed 23 Oct. 2009, of Comerford, et al, entitled “Lifting Device and Method for Concrete Elements”, now U.S. Pat. No. 9,409,751, which derives from PCT Application No. PCT/AU2009/001401, and claims priority from Australian provisional patent application no. AU 2008905461 filed on 23 Oct. 2008. All of the above-referenced patent documents are hereby expressly incorporated herein by reference as if set forth in their entirety.

### FIELD OF THE INVENTION

The present invention relates to methods and apparatuses for achieving mechanical interlock between a brittle base material (such as concrete or other similarly brittle materials) and a mechanical device.

In particular, the method of the present invention transfers forces between the base material and a further object that is connected to the base material via the mechanical device.

Most particularly, the present invention relates to an undercutting tool and the use of the undercutting tool in the method of lifting brittle elements. In some embodiments, the invention is directed to an undercutting tool for producing undercuts in pilot bores in concrete, cement, rock and the like, although the scope of the invention is not necessarily limited thereto.

### DESCRIPTION OF THE ART

Lifting and handling of brittle elements such as concrete, rock and masonry is typically done by use of a crane or other lifting machine which is connected via a rigging to one or a number of lifting inserts permanently embedded in the brittle element to be lifted. These lifting inserts can alternatively be used as anchorage points.

Examples of such lifting inserts/anchors are U.S. Pat. No. 4,000,591, U.S. Pat. No. 4,367,892, U.S. Pat. No. 4,386,486, U.S. Pat. No. 4,437,642 and U.S. Pat. No. 4,580,378. In addition, techniques such as protruding loops of cable, wire loop and reinforcing bar have also been used to provide a lifting insert/anchor for attachment. The crane rigging may attach to the lifting insert via (for example) a lifting clutch, shackle, hook, lifting eye or any suitable attachment means or combination of.

One example of extensive use of lifting inserts/anchors is in the pre-cast manufacture of panels, slabs and pre-stressed bridge beams where the lifting inserts are embedded during the casting process. Once the brittle element has been cast in a pre-caster facility, then the lifting inserts are used to lift the brittle element from the floor or from the moulding/casting form in which it is made. The brittle element panels are then typically placed on racks or stacked to allow the element to gain strength prior to being delivered to a construction site. The delivery to the construction site requires a lift onto a transporter and then a subsequent lifting and handling to position the brittle element in the construction project. The embedded lifting inserts remain in the brittle element and are of no further use.

However, none of these prior art devices and methods provides an entirely satisfactory solution to the provision of lifting and handling of brittle elements that were never prepared for lifting, nor for use as an anchor, nor to the ease of use and verification of a safe lifting operation.

A solution to the deficiencies of the prior art is to utilise a frustoconical cavity in the brittle element. The frustoconical cavity is a substantially conical cavity that is ground, carved, cut, cast or otherwise shaped into the brittle material at one end of a pilot borehole, arranged such that the ‘point’ of the conical cavity is substantially pointing towards the pilot bore entrance—in effect giving the borehole and cavity an overall trumpet-like shape.

These cavities provide ideal locations for non-permanent lifting devices or anchors to engage with the brittle element, without causing undue levels of tensile stress that may damage the element.

Undercutting tools may be used to produce a frustoconical undercut in a bore made in a brittle element, such as a concrete material or a similar substance. This allows brittle elements that were not previously prepared for lifting to be suitably adapted. Undercutting tools are available in the marketplace and are used to produce undercuts in bore walls of concrete and the like.

A problem with existing undercutting tools is that the time taken to undercut a hole can be relatively long, as some of the tools require constant re-adjustment by an operator. Existing undercutting tools are complex and usually have a lot of moving parts to be able to adequately undercut a bore by forcing the cutting part against the bore wall. For example United States patent no. U.S. Pat. No. 4,502,554 discloses a rotary power tool for reaming frustoconical undercuts into cylindrical holes by forcing cutting blades outwardly using a ram, to undercut the wall of the hole.

Another disadvantage with existing undercutting tools is that the complex mechanisms used to force the cutting part against the bore wall have to be disengaged before the tool can be removed from the bore hole, which is time consuming and in some instances can lead to tools becoming stuck in the bore. Safety is also a great concern with existing undercutting tools, with many operators leaving the tool attached to the drill while the tool is being adjusted. Accidental activation of the drill in these circumstances can lead to serious injuries.

Prior art examples of undercutting tools exhibit use of cutting edges to chip away at and extract the rock, concrete or other brittle material being undercut. The majority of undercutting tools available for industrial use are adapted to cut, chip, ream or otherwise carve the brittle material to create the necessary cavity or void.

However, as is well known, brittle materials do not respond well to cutting means and will frequently fracture. Even if the fracture is not immediately visible (for example, hairline fractures or microscopic cracks) these can still significantly weaken the integrity of the brittle element being undercut. Concrete, for example, has limited tensile strength even when perfectly cast. This is a significant problem for situations wherein the void will form part of an anchoring point or point of contact for the lifting and manoeuvring of the brittle elements. Materials such as concrete, rock and masonry are well known for, and characterised by, their inability to endure tensile stresses and their tendency to fracture under application of pressure. This results in the production of microscopic fractures around the undercutting site, which can weaken the structural integrity of the brittle element. Furthermore, the cutting, carving or reaming means tend to produce irregular internal surfaces which provide unsuitable locations for the mechanical interlock of lifting devices or anchors with the brittle element.

This is of particular importance where the brittle elements are being lifted, moved or otherwise subjected to tensile stresses—for example, where the brittle element is being used as an anchor for an object, should the object move away from the element, then the tethering anchor will place tensile forces upon the element.

It will be clearly understood that any reference herein to background material or information, or to a prior publication, does not constitute an admission that any material, information or publication forms part of the common general knowledge in the art, or is otherwise admissible prior art, whether in Australia or in any other country.

### SUMMARY OF THE INVENTION

The present invention aims to build upon the disclosure of U.S. Pat. No. 9,409,751 by further providing a system and method by which the device disclosed in that application can be used with a range of brittle elements.

According to a first embodiment of the invention, there is provided a system for the lifting of brittle elements that are otherwise not adapted for lifting. The system comprises a brittle element that has a bore hole pre-drilled into it, but is otherwise unprepared for lifting; use of an undercutting tool to produce a frustoconical lifting void with a specified frustoconical angle within the bore hole and a lifting device adapted to engage with the frustoconical lifting void.

A further embodiment of the invention provides a method for producing an undercut in a bore, the undercutting tool comprising a tool body which can be at least partially inserted into the bore that is to be undercut; a wedge moveably attached to the tool body such that the wedge is displaced outwardly by centrifugal force when the undercutting tool is rotated at a sufficient rate, and an undercutting means associated with the wedge that is also displaced outwardly.

Reference to “wedges” herein can also refer to one wedge. Reference to “undercutting means” herein can also be inferred in a singular or plural manner.

The undercutting tool should be adapted so as to be able to rotate in the bore that is to be undercut. The tool body may have one or more connection points to enable wedges to be attached to the tool body. The connection points may be holes, threaded bores, slots, openings and/or the like in the tool body. Alternatively the connection points may be arms, fingers, coupling members, supports, projections and/or the like on the tool body.

The wedges may have one or more connecting portions. The one or more connecting portions on the wedges may be connected to one or more connection points on the tool body. Normally the connecting portions and connection points are connected using, a connecting member such as a pin, split pin, bolt, cable clamp, coupling, dowel, hook, keeper, rivet, screw, fastener and/or the like. Alternatively the wedges and the tool body can be connected together using a captive arrangement, sliding joint, hinge, flexible material, welding and/or the like.

In a further embodiment, the wedges may be restricted from excess outward displacement. This may through the shape or configuration of the tool body wherein it abuts the wedges once they have outwardly displaced to a defined angle, thereby preventing further displacement; alternatively, there may be projections from the tool body or from the connection points that serve a similar purpose.

### BRIEF DESCRIPTION OF THE DRAWINGS

FIG. 1A is a diagram detailing a number of angles relating to the application of force to a brittle element;

FIG. 1B is a diagram showing a form of failure of a brittle element;

FIG. 2 is a diagram showing an aspect of the current invention;

FIG. 3 is a diagram of a lifting device substantially embodying the invention disclosed in U.S. Pat. No. 9,409,751.

### DETAILED DESCRIPTION OF THE INVENTION

An aspect of the current invention utilises undercutting means associated with the wedges of an undercutting tool. Preferably, these undercutting means are abrasive pads or surfaces that grind the surface of the brittle material, rather than chip at or cut at it. By utilising abrasive or grinding means as opposed to cutting means, the applied force is spread over a larger area, thereby limiting the pressure applied to the brittle material. This serves to inhibit extraneous damage that may be done to the brittle material, thereby maximising the integrity of the resulting lifting void that is ground out of the brittle element.

Utilising grinding or abrasive surfaces for undercutting means has further advantages in that it is far more likely to result in the lifting void that is formed using the undercutting tool having an evenly curved and smooth surface with few aberrations. Accordingly, anchors or lifting devices that engage with the lifting void will engage with an even and undisrupted surface, minimising the transmission of adverse forces by the lifting device upon the surface of the void formed in the brittle element. The final advantage of the use of abrasion is that the brittle material becomes dust, powder or otherwise small granular material, rather than small gravel chips as may occur should the brittle material be cut. This permits a more efficient use of water flushing processes to remove the waste product from the borehole.

Given that the main use of the void carved by the undercutting tool is to engage with a lifting device, it is clear that the angle away from vertical formed by the walls of the lifting void will be of importance.

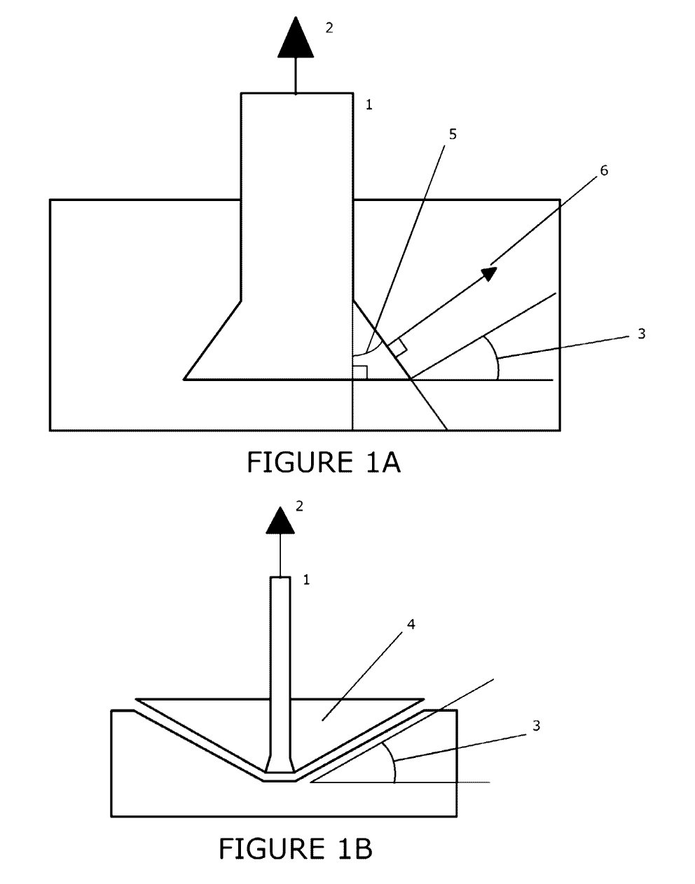

For example, a greater angle away from vertical will permit a greater proportion of direct transmission of force, overall lowering the force requirements to lift a given mass. However, there is also a greater likelihood of material failure. With reference to FIGS. 1A and 1B, the failure properties of brittle elements, such as concrete, were calculated in order to optimise the angle between the surface of the lifting void and the lifting device.

By applying varying levels of force to a lifting device 1, which substantially embodies the invention disclosed by U.S. Pat. No. 9,409,751, the nature of how brittle elements, such as concrete fail was calculated. One commonly used material in construction and infrastructure projections is concrete, which is well known for its brittle nature and inability to cope with tensile stress, relative to its compressive strength.

With reference to Table 1 below, it was found that the average compressive force that could be applied to concrete before failure occurred was 305 kN. This correlates to an average compressive strength of 38.7 MPa.

TABLE 1
Compressive Strength of Concrete

| Cylinder | Compressive | Compressive |
|---|---|---|
| ID | Force (kN) | Strength (MPa) |
| I | 313 | 39.7 |
| 2 | 320 | 41.0 |
| 3 | 299 | 38.4 |
| 4 | 294 | 37.4 |
| 5 | 305.6 | 38.7 |
| 6 | 302 | 37.8 |
| 7 | 304 | 38.8 |
| 8 | 300 | 38.1 |

This can be compared to Table 2, which displays the results for a number of tests conducted on concrete slabs of different thicknesses. The application of tensile or shear stress to concrete resulted in a significantly lower peak applied force before failure of the material. While the peak applied force is clearly also dependent upon the thickness of the concrete slab, there is a theoretical upper limit to the effect of slab thickness upon the ability of concrete or other brittle elements to resist tensile forces.

TABLE 2
Edge and Face Concrete Stress Tests

| Slab | | Peak |
|---|---|---|
| Thickness (mm) | Test Type | Force (kN) |
| 125 | Edge Shear | 8.45 |
| 150 | Edge Shear | 16.38 |
| 200 | Edge Shear | 21.475 |
| 125 | Edge tension | 64.05 |
| 150 | Edge tension | 86.5 |
| 200 | Edge tension | 113 |
| 250 | Face Shear | 90.4 |
| 250 | Face Tension | 136.9 |

As best shown in FIG. 1B, it was further found that when an internally-engaged anchor or lifting device 1 is subjected to a force in direction 2, so as to place tensile stress upon the brittle element, it was found that concrete would fail in a ‘shear cone’ 4.

Stress fractures would radiate outwards in a conical array from the engagement point between the anchor and the brittle element, wherein the stress fractures would propagate at an angle 3 between the direction of application of force and perpendicular to said force direction. As concrete is a brittle material, these initial stress fractures would rapidly propagate in a conical array, resulting in total conical shear failure as shown in FIG. 1B.

It was further found that the angle of the initial stress fractures 3 would fall between about 20 degrees to about 32 degrees, averaging about 25 degrees away from perpendicular and towards the direction of application of force.

It is further known that applying a lifting force 2 to a lifting device 1 substantially embodying U.S. Pat. No. 9,409,751 will result in the force transferring through the engaging fingers of the lifting device 1 to the engaged brittle element in a direction substantially normal to the engaging surface of the engaging finger. This is the ‘transmitted force’ vector 6, best shown in FIG. 1A. When the transmitted force vector is at an angle greater than the angle of initial stress fracture (approx. 20 degrees to approx. 32 degrees), the brittle element undergoes substantially shear or tensile stress induced by the engaging fingers which results in the formation of the initial stress fractures.

As the stress fractures are both formed and exacerbated due to the application of either tensile or shear stress, it considered advantageous to utilise compressive force to lift a brittle element.

With reference to FIG. 1A, the frustoconical angle 5, which is equal to the angle of displacement of the engaging finger of the lifting device, must be less than the angle of stress fracture 3. This ensures that the angle between the transmitted force vector 6 and the base of the lifting device 1 is lower than the angle of the initial stress fractures 3. As a result, the force transmitted from the lifting device (through the engaging fingers) and to the brittle element will induce compressive stress as opposed to tensile stress. Any stress fractures that may be present within the brittle element will not be exacerbated or further torn open. This allows for a greater level of force to be applied to a lifting device, thus allowing for larger and heavier brittle elements to be lifted and manoeuvred without material failure occurring.

However, it is also known from U.S. Pat. No. 9,409,751 that one factor affecting the load capacity of the lifting device includes the volume of the ‘pull out cone’ of the brittle element that the lifting device is acting upon. A ‘pull out cone’ is defined by the cone formed by the direction of the transmitted force vector 6. The volume of the pull out cone is inversely proportional to the frustoconical angle 5. As is mathematically clear, a more acute frustoconical angle 5 will result in a larger pull-out cone volume, while a more obtuse frustoconical angle 5 will reduce the volume of the pull-out cone.

In other words, the ‘useful’ application of force is inversely proportional to the pull-out cone volume. A lowered pull-out cone volume (due to a more obtuse frustoconical angle 5) means that when the lifting device is subject to a lifting force, a greater proportion of this lifting force is transferred to the engaged brittle element in the direction necessary to lift said element—the transmitted force vector 6 is closer to the applied force vector 2. This therefore creates a lower limit on the frustoconical angle 5, as a frustoconical angle 5 that is too acute will result in unnecessary energy expenditure. A greater applied force 2 will be needed to produce the required transmitted force 6 to generate lift.

Furthermore, it was calculated that if the frustoconical angle is less than about 12 degrees, the lifting device cannot properly engage with the frustoconical lifting void and slippage will occur.

Therefore, a successful lifting device must engage with a brittle element in a manner such that its pull-out cone is minimised (to ensure the greatest efficiency possible), but the pull-out cone must be greater in size compared to the theoretical ‘shear cone’ 4 of the material. If the pull-out cone falls wholly within the volume of the projected shear cone 4, then the brittle element is being subjected to sufficient shear and tensile stress, which may form initial stress fractures that can then rapidly propagate and cause conical failure of the material.

Accordingly, the frustoconical lifting void formed by the tool of the present invention should have a frustoconical angle 5 that is greater than about 12 degrees, so as to ensure a minimised ‘pull out volume’, but less than about 32 degrees, so as to ensure that the pull-out cone is greater in size than the shear cone.

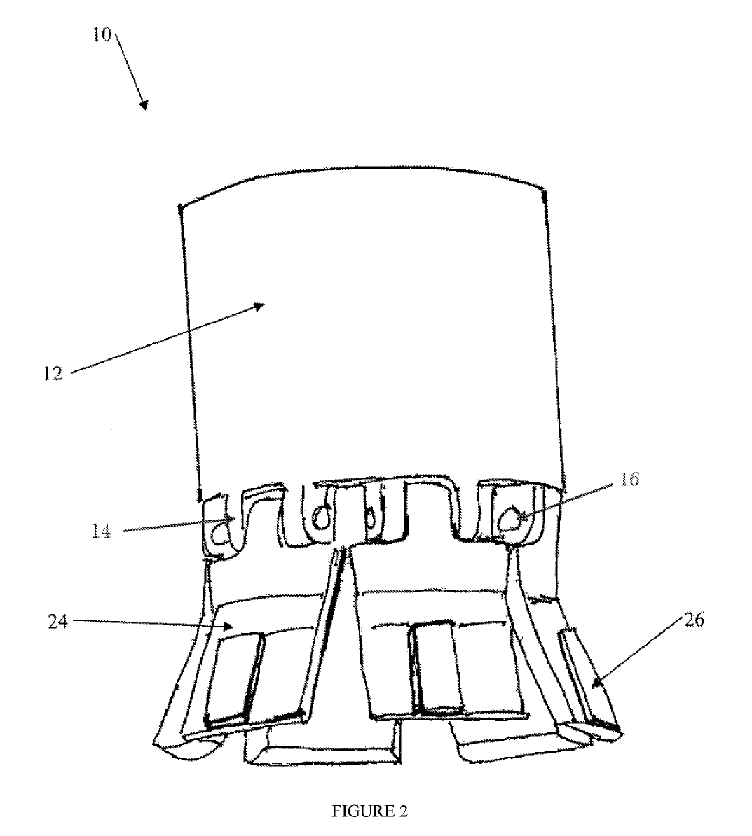

An aspect of the present invention is shown in FIG. 2, which shows an undercutting tool 10, which has a tool body 12 that is substantially cylindrical in shape. The cross-sectional diameter of the tool body 12 is selected so as to permit the undercutting tool 10 to be at least partially inserted into a bore hole that has been drilled, carved, bored or otherwise shaped into the brittle element to be lifted.

The terminal end of the tool body 12 features a hinged connection point 14 and associated connecting pin 16 serving to connect a wedge 24. The wedge 24 will, when the undercutting tool 10 is at rest, hang such that it falls substantially within the circular cross-sectional profile of the tool body 12. This ensures that the undercutting tool 10 may be easily fitted into the bore hole that is to be frustoconically undercut. The wedge 24 may be capable of biasing further inwards (towards the central axis of the undercutting tool 10) so as to provide further aid for insertion of the undercutting tool 10 into the bore hole to be undercut. The hinged connection point 14 is configured so as to define the maximum outward angle to which the wedge 24 may displace. This angle is between about 15 and about 32 degrees. The angle that works best is 20 degrees.

The tool of the current invention also includes an abrasive pad 26 at least partially covering the outer surface of the wedge 24. The abrasive pad is typically formed of a material hard enough to abrade cement and is shaped so as to ensure that the entire outer surface of the abrasive pad 26 will press against the inner wall of the bore hole.

A further aspect of the invention is a system comprising the undercutting tool of the current invention and a lifting device substantially embodying the invention disclosed in U.S. Ser. No. 13/125,593.

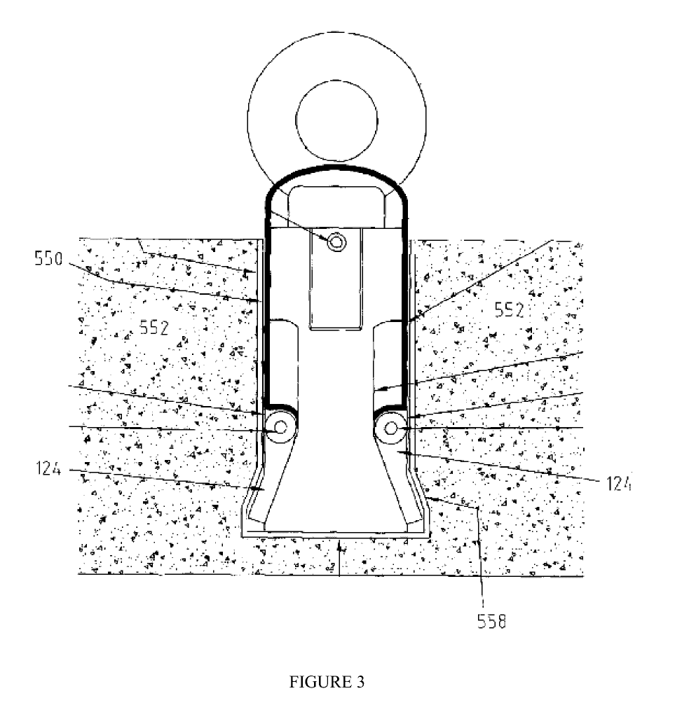

FIG. 3 is a diagram of a lifting device substantially embodying U.S. Pat. No. 9,409,751 engaged with a bore hole that has a frustoconical lifting void 558 shaped into it. A brittle element 552, such as concrete, is pre-prepared by having a pilot bore 550 hole drilled, reamed, carved or otherwise formed into the brittle element 552. The pilot bore 550 should be of substantially similar diameter as that of the tool body 12 of the undercutting tool 10 shown in FIG. 2. The undercutting tool 10, which is connected to a drill, hand drill, auger or other powered rotational device, may then be at least partially inserted into the pilot bore 550 and activated. Upon activation of the undercutting tool 10, it will be rotated at sufficient rotational velocity such that the wedges 24 are driven outwards by centrifugal force. This will result in the abrasive pads 26 being brought into contact with the brittle element 552, at which point the abrasive pads 26 will begin to grind away at the material of the brittle element 552.

The wedges 24 will continue to be outwardly displaced by centrifugal force until the wedges 24 have reached the maximum angle as defined by the shaped protrusions, abutments or other abutting means of the connection points 14 on the terminal end of the tool body 12. This angle is between about 15 degrees to about 32 degrees so as to fall within the lower and upper limits as defined by the pull-out cone and the shear cone properties of the brittle element. As detailed above, the best angle is 20 degrees.

Once the defined angle has been reached, the undercutting tool 10 is deactivated and withdrawn from the pilot bore 550 that now has a frustoconical lifting void 558 shaped within it. The lifting device may then be inserted and engaged with the lifting void 550 wherein the engaging fingers 124 outwardly displace to the same angle as the maximum grinding angle of the undercutting tool wedges 24.

In this way, there is a precise fit between each of the engaging fingers and the interior surface of the frustoconical void, such that the engaging fingers may be urged into contact with the surface of the frustoconical void. When a lifting force is applied to the lifting device substantially in the direction of the axis of the tool body, the lifting force is transferred to the brittle element through the engaging fingers such that the transferred force is a substantially compressive force, which minimises the possibility of stress fracture of the brittle element that is being lifted.

In order to facilitate the lifting of the brittle element, the lifting device may then have a lifting means attached to the device, typically by means of the attachment ring 116 or whatever attachment means the lifting device may utilise. In this manner the undercutting tool 10 and lifting device are functionally interlinked.

Although the invention has been herein shown and described in what is conceived to be the most practical and preferred embodiments, it is recognized that departures can be made within the scope of the invention, which are not to be limited to the details described herein but are to be accorded the full scope of the appended claims so as to embrace any and all equivalent assemblies, devices and apparatus.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises” where they appear.

It will further be understood that any reference herein to known prior art does not, unless the contrary indication appears, constitute an admission that such prior art is commonly known by those skilled in the art to which the invention relates.

What is claimed is:

1. A system for lifting a brittle element having a substantially cylindrical bore hole drilled, cut or otherwise bored into a surface thereof, the system comprising:
a tool for adapting the bore hole for engagement with a lifting device through formation of a frustoconical void within the bore hole, the tool comprising:
a tool body, the tool body being configured to be at least partially inserted into the bore hole;
a connection point on the terminal end of the tool body;
a wedge hingedly attached to the connection point, wherein the wedge is arranged to point in substantially the same direction as an axis of the tool body, the axis being in the same direction in which the undercutting tool is inserted into the bore hole;
wherein the connection point is configured so as to abut the wedge and prevent further outward pivoting once an angle from about 15 degrees to about 25 degrees outwards from the axis of the tool body is reached; and
an abrasive pad on an outer surface of the wedge;
wherein upon application of centrifugal force, the tool rotates about the axis of the tool body, and the wedge outwardly pivots around the hinged attachment between the wedge and the connection point up to the maximum angle;
wherein the outward pivoting of the wedge urges the abrasive pad into contact with the wall of the bore hole and induces abrasion of the brittle element so as to produce the frustoconical void; and
wherein the abrasive pad limits the inducement of aberrations and fractures in the material of the brittle element beyond the frustoconical void; and
a lifting device adapted to engage with the frustoconical void, the lifting device comprising at least a substantially cylindrical body that defines an axis that is oriented substantially longitudinally with respect to the cylindrical body, a means of applying a lifting force, an engaging finger and a means of operatively transforming the lifting device between an insertion configuration and a lifting configuration, wherein:
the insertion configuration is such that the lifting device may be inserted into or withdrawn from the bore hole;
the lifting configuration is such that the engaging finger may be urged into contact with the surface of the frustoconical void; and
wherein a lifting force applied to the lifting device substantially in the direction of the axis is transferred to the brittle element through the engaging finger such that the transferred force on the brittle element is substantially compressive.

2. A method for lifting a brittle element comprising the steps of:
using a lifting device comprising at least a substantially cylindrical body, a means of applying a lifting force, an engaging finger and a means of operatively transforming the lifting device between an insertion configuration and a lifting configuration, wherein:
the insertion configuration is such that the lifting device may be inserted into or withdrawn from a bore hole that has been formed in the brittle element;
the lifting configuration is such that the engaging finger may be urged into contact with the surface of a frustoconical void formed within the bore hole; and
wherein a lifting force applied to the engaged lifting device is transferred to the brittle element through the engaging finger such that the transferred force is a substantially compressive force;
engaging the lifting device to a brittle element comprising the steps of:
drilling, reaming, cutting, boring or otherwise shaping a substantially cylindrical bore hole into the brittle element;
configuring a frustoconical void in the brittle element to receive the lower end of the lifting device, wherein the angle between the conical surface of the frustoconical void and the longitudinal axis of the bore hole is from about 15 degrees to about 25 degrees;
inserting the lower end of the lifting device into the cavity;
transforming the lifting device into the lifting configuration; and
applying a lifting force to the brittle element.

3. A tool for producing a frustoconical void in a bore, the tool comprising:
a tool body having one or more connection points provided on a terminal portion of the tool body, the tool body being configured to be at least partially inserted into the bore that is to be undercut;
a plurality of wedges, each wedge being pivotably attached to the tool body;
a plurality of pivot pins secured to the tool body, each pivot pin corresponding to a particular wedge, wherein each wedge pivots about its corresponding pivot pin; and
wherein each wedge has an outer surface and an abrasive surface attached to the outer surface and wherein each wedge and abrasive surface are displaced outwardly by centrifugal force resulting from rotation of the undercutting tool, whereby the angle between each wedge and the tool body increases as the speed of rotation increases so as to cause the abrasive surfaces of the wedges to produce a frustoconical undercut in the bore.

4. The tool of claim 3, wherein the tool body has a substantially cylindrical profile.

5. The tool of claim 3, wherein the elements of the tool other than the tool body are shaped so as to be located substantially within the profile of said tool body when the undercutting tool is not subject to a centrifugal force.

6. The tool of claim 4, wherein the elements of the tool other than the tool body are shaped so as to be located substantially within the profile of said tool body when the undercutting tool is not subject to a centrifugal force.
